(19) United States
(12) Patent Application Publication
(10) Pub. No.: US 2025/0271737 A1
(43) Pub. Date: Aug. 28, 2025

(54) PROJECTOR

(71) Applicant: SEIKO EPSON CORPORATION, Tokyo (JP)

(72) Inventor: Nobuyuki OTSUKI, MATSUMOTO-SHI (JP)

(21) Appl. No.: 19/065,250

(22) Filed: Feb. 27, 2025

(30) Foreign Application Priority Data
Feb. 28, 2024 (JP) 2024-028687

(51) Int. Cl. G03B 21/14; G01S 7/481; G01S 17/86; G03B 21/20

(52) U.S. Cl. CPC G03B 21/145; G01S 7/4813; G01S 17/86; G03B 21/208; G03B 21/2066

(57) ABSTRACT

A projector includes an exterior housing having a projection port and a passage port, a projection optical device, a cover, and a ranging device configured to emit and receive detection light, in which the projection optical device includes a front lens, and projects a image light such that a projection range of the image light moves toward one side in a second direction as moving in a first direction when a direction along a lens optical axis of the front lens is defined as the first direction and a direction orthogonal to the first direction is defined as the second direction, the ranging device includes a substrate and a sensor, and the substrate is disposed to be inclined with respect to a virtual plane so that a detection light of the sensor points at a projection range of the image light by the projection optical device.

The present application is based on, and claims priority from JP Application Serial Number 2024-028687, filed Feb. 28, 2024, the disclosure of which is hereby incorporated by reference herein in its entirety.

### BACKGROUND

### 1. Technical Field

The present disclosure relates to a projector.

### 2. Related Art

In the past, there has been known a projector that modulates light emitted from a light source and projects image light corresponding to image information. As such a projector, there has been known a projector including an infrared light emitting unit, an infrared light receiving block, a position calculation unit, a microcomputer, and a moving block for moving the projector itself (see, for example, JP-A-2011-221081).

In the projector described in JP-A-2011-221081, the infrared light receiving block receives infrared light which is emitted by the infrared light emitting unit, and is then reflected by a reflection marker on a screen. The position calculation unit outputs information corresponding to an installation position of the reflection marker on the screen to the microcomputer based on the infrared light received by the infrared light receiving block. The microcomputer calculates the size of the screen based on the information output by the position calculation unit, and reads out the projection distance associated with the size of the screen thus calculated. The microcomputer calculates a difference between a distance to the screen thus calculated using ultrasonic wave and the projection distance thus read out, and then outputs information representing a movement amount corresponding to the difference thus calculated and a control signal to a moving block. The moving block moves the projector itself in accordance with the information and the control signal input from the microcomputer.

Accordingly, it is possible to save time and effort for the operator to move the projector to adjust the size of the image to be displayed on the screen.

JP-A-2011-221081 is an example of the related art.

As described above, the projector described in JP-A-2011-221081 receives the infrared light reflected by the screen.

Here, in order to accurately measure the distance to the screen, that is, the projection distance of the image light, the irradiation range of the infrared light as the detection light preferably includes the projection range of the image light. Since it is difficult to dispose the infrared light emitting unit and the infrared light receiving unit on an optical axis of a projection optical device, the infrared light emitting unit and the infrared light receiving unit are generally disposed at positions away from the optical axis of the projection optical device.

However, when the infrared light emitting unit and the infrared light receiving unit are disposed at positions away from the optical axis of the projection optical device, a deviation is apt to occur between the projection range of the image light and the detection range of the detection light, and there is a problem that the detection accuracy of the detection light and, by extension, the ranging accuracy are lowered.

Therefore, a configuration capable of improving the detection accuracy with the detection light has been desired.

### SUMMARY

A projector according to an aspect of the present disclosure includes an exterior housing having a first surface provided with a projection port and a passage port, a projection optical device configured to project image light through the projection port, a cover having a light transmissive property, and disposed corresponding to the passage port, and a ranging device configured to emit and receive detection light through the cover, in which the projection optical device includes a front lens located at an exit side of the image light, and projects the image light such that a projection range of the image light moves toward one side in a second direction as moving in a first direction when a direction along a lens optical axis of the front lens is defined as the first direction and a direction orthogonal to the first direction is defined as the second direction, the ranging device includes a substrate, and a sensor which includes a light emitting element configured to emit the detection light and a light receiving element configured to receive the detection light emitted from the light emitting element, and is disposed on the substrate, and the substrate is disposed to be inclined with respect to a virtual plane orthogonal to the lens optical axis about an axis along a third direction crossing each of the first direction and the second direction so that the detection light emitted from the light emitting element points at a projection range of the image light by the projection optical device.

### BRIEF DESCRIPTION OF THE DRAWINGS

FIG. 1 is a perspective view showing an appearance of a projector according to a first embodiment.

FIG. 2 is a diagram illustrating a front of a projector according to the first embodiment.

FIG. 3 is a schematic diagram illustrating a configuration of an image projection apparatus according to the first embodiment.

FIG. 4 is a schematic diagram illustrating a light path of image light related to the first embodiment.

FIG. 5 is a perspective view illustrating an inner surface of a front surface related to the first embodiment.

FIG. 6 is a perspective view showing a ranging device related to the first embodiment.

FIG. 7 is a perspective view showing the ranging device related to the first embodiment.

FIG. 8 is a perspective view showing a fixation structure of the ranging device related to the first embodiment.

FIG. 9 is a cross-sectional view showing the projector according to the first embodiment.

FIG. 10 is a cross-sectional view showing an exterior housing and a ranging device provided to a projector according to a second embodiment.

FIG. 11 is a cross-sectional view showing an exterior housing and a ranging device provided to a projector according to a third embodiment.

FIG. 12 is a cross-sectional view showing an exterior housing, a ranging device, and a support member provided to a projector according to a fourth embodiment.

FIG. 13 is a diagram showing an inclined state of a substrate in a projector according to a fifth embodiment.

### DESCRIPTION OF EMBODIMENTS

### First Embodiment

A first embodiment of the present disclosure will hereinafter be described based on the drawings.

### Schematic Configuration of Projector

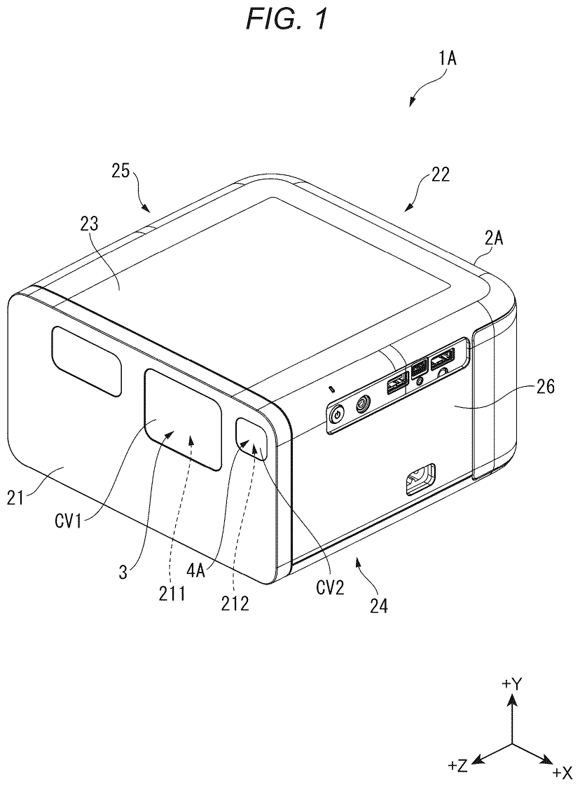

FIG. 1 is a perspective view showing an appearance projector 1A according to the present embodiment.

The projector 1A according to the present embodiment modulates light emitted from a light source to generate image light according to image information, and projects the image light thus generated onto a projection target surface such as a screen in an enlarged manner. As illustrated in FIG. 1, the projector 1A includes an exterior housing 2A, an image projection apparatus 3, and a ranging device 4A. Besides the above, although not illustrated in the drawings, the projector 1A includes a control device that controls an operation of the projector 1A, a power supply device that supplies power to electronic components constituting the projector 1A, and a cooling device that cools a cooling target in the projector 1A.

### Configuration of Exterior Housing

The exterior housing 2A is a chassis forming an exterior of the projector 1A, and is configured in a substantially rectangular parallelepiped shape. The exterior housing 2A has a front surface 21, a back surface 22, a top surface 23, a bottom surface 24, a left side surface 25, and a right side surface 26.

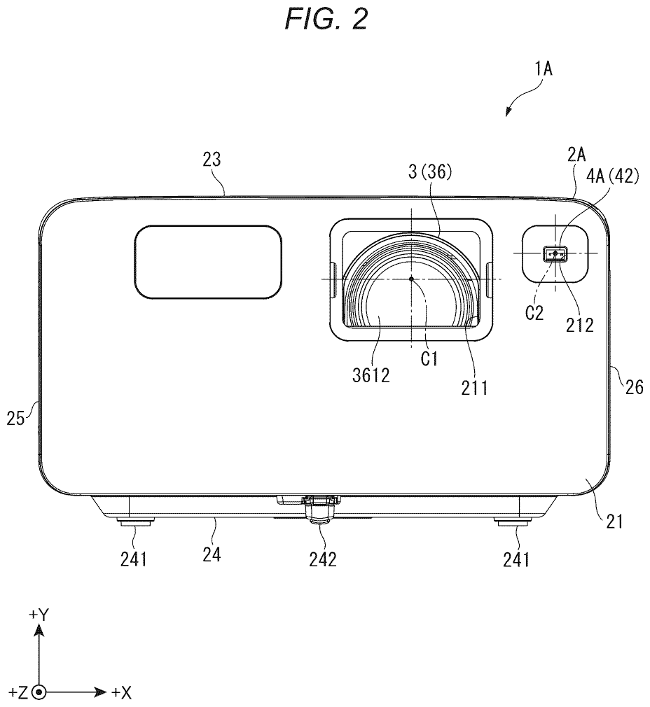

FIG. 2 is a diagram illustrating the front surface 21. Particularly, FIG. 2 is a diagram illustrating the front surface 21 in a state where the covers CV1, CV2 are detached.

The front surface 21 corresponds to a first surface. The front surface 21 and the back surface 22 are opposite to each other.

The front surface 21 crosses the top surface 23, the bottom surface 24, the left side surface 25, and the right side surface 26. As shown in FIGS. 1 and 2, the front surface 21 is provided with a projection port 211 and a passage port 212.

The projection port 211 is an opening through which the image light projected by a projection optical device 36 of the image projection apparatus 3 described later passes. As illustrated in FIG. 1, the projection port 211 is provided with a cover CV1 that has a light transmissive property and transmits at least visible light. The image light projected by the projection optical device 36 is transmitted through the cover CV1.

The passage port 212 is an opening through which the detection light emitted from the ranging device 4A described later and then reflected by the outside of the exterior housing 2A passes. The passage port 212 is disposed at the right side surface 26 side with respect to the projection port 211. That is, the passage port 212 is disposed at a +X direction side described later with respect to the projection port 211. Further, as illustrated in FIG. 2, the center C2 of the passage port 212 in a direction from the bottom surface 24 toward the top surface 23 is disposed at the top surface 23 side from the center C1 of the projection port 211 in the same direction. That is, the center C2 of the passage port 212 on the Y axis described later is located at the +Y direction side from the center C1 of the projection port 211 on the Y axis.

As illustrated in FIG. 1, the passage port 212 is provided with a cover CV2 that has a light transmissive property, and transmits infrared light. In other words, the cover CV2 is provided to the exterior housing 2A in accordance with the passage port 212. The detection light emitted from the ranging device 4A is transmitted through the cover CV2. With such a cover CV2, the external appearance of the projector 1A can be improved, and measures against static electricity can be taken for a sensor 42 of the ranging device 4A.

Note that the ranging device 4A is disposed inside the exterior housing 2A so as to correspond to the passage port 212. A configuration of the ranging device 4A will be described later in detail.

As shown in FIGS. 1 and 2, the top surface 23 and the bottom surface 24 are surfaces opposite to each other. The bottom surface 24 is a surface facing an installation surface.

As shown in FIG. 2, the bottom surface 24 is provided with leg parts 241, 242 that come into contact with the installation surface on which the projector 1A is installed. The leg part 241 is a fixed leg part disposed at a position at the back surface 22 side on the bottom surface 24. The leg part 242 is an adjustable leg part disposed at a position at the front surface 21 side on the bottom surface 24. The protrusion amount of the leg part 242 from the bottom surface 24 is adjustable. By adjusting the protrusion amount of the leg part 242, the projector 1A can be disposed to be inclined with respect to the installation surface so that a distance between the installation surface and a point on the bottom surface 24 increases as the point moves from the back surface 22 toward the front surface 21. Accordingly, the projection range of the image light can be adjusted in a direction from the bottom surface 24 toward the top surface 23. Note that the projector 1A according to the present embodiment can be used in a posture in which the top surface 23 faces upward, and can also be used in a posture in which the bottom surface 24 faces upward.

The left side surface 25 and the right side surface 26 are surfaces opposite to each other.

### Configuration of Image Projection Apparatus

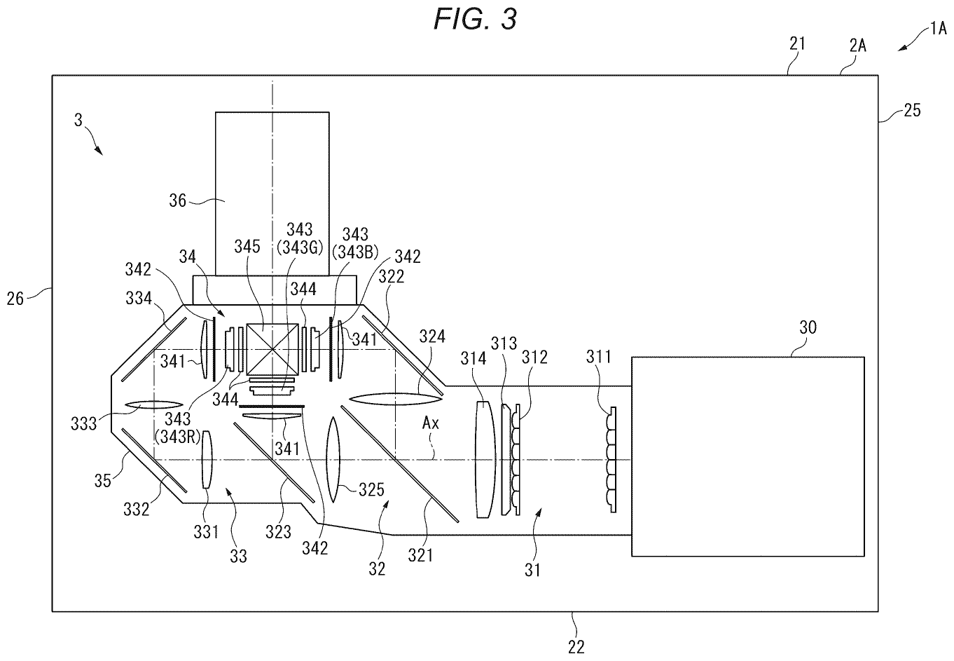

FIG. 3 is a schematic diagram illustrating a configuration of the image projection apparatus 3.

The image projection apparatus 3 is housed in the exterior housing 2A. The image projection apparatus 3 projects the image light according to the image information under the control of the control device described above. As shown in FIG. 3, the image projection apparatus 3 includes a light source 30, a homogenizing device 31, a color separation device 32, a relay device 33, an image forming device 34, an optical component housing 35, and the projection optical device 36, and is configured as a substantially L-shaped optical unit.

The light source 30 emits illumination light for illuminating light modulation elements 343 of the image forming device 34. Examples of a configuration of the light source 30 include a configuration including a light emitting element such as a laser diode (LD) or a light emitting diode (LED), a configuration including a light emitting element and a wavelength conversion element that converts the wavelength of incident light, and a configuration including a discharge light source lamp such as an ultra-high pressure mercury lamp.

The homogenizing device 31 homogenizes the illuminance distribution of the light incident from the light source 30. The homogenizing device 31 includes a first lens array 311, a second lens array 312, a polarization conversion element 313, and a superimposing lens 314 in the order of incidence of light from the light source 30.

The color separation device 32 separates the light incident from the homogenizing device 31 into a red light beam, a green light beam, and a blue light beam. The color separation device 32 includes dichroic mirrors 321, 322, a reflecting mirror 323, and lenses 324, 325.

The relay device 33 is disposed on a light path of the red light beam longer in light path than the green light beam and the blue light beam out of the three colored light beams thus separated. The relay device 33 includes an incident side lens 331, a relay lens 333, and reflecting mirrors 332, 334.

The image forming device 34 modulates the colored light beams separated from each other in accordance with the image information, and then combines the colored light beams thus modulated with each other to form image light. The image forming device 34 includes three field lenses 341, three incident side polarization plates 342, three light modulation elements 343, and three exit side polarization plates 344 provided so as to correspond to the colored light beams, and a single color combining element 345.

Each of the light modulation elements 343 modulates incident colored light beam. The three light modulation elements 343 include a red light modulation element 343R, which modulates the red light beam, a green light modulation element 343G, which modulates the green light beam, and a blue light modulation element 343B, which modulates the blue light beam. In the present embodiment, each of the light modulation elements 343 is configured with a transmissive liquid crystal panel in which a plane of incidence on which the corresponding colored light beam is incident and an exit surface from which the modulated light is emitted are opposite to each other. That is, the image forming device 34 includes, for each of the three colored light beams, a liquid crystal light valve including the light modulation element 343 that is a liquid crystal panel, and the incident side polarization plate 342 and the exit side polarization plate 344 that sandwich the light modulation element 343.

The color combining element 345 combines the modulated light beams modulated by the respective light modulation elements 343 to each other to generate full-color image light. In the present embodiment, the color combining element 345 is configured with a cross dichroic prism, but may be configured with a plurality of dichroic mirrors.

The optical component housing 35 houses the devices 31 to 33 described above and the field lens 341 inside. An illumination light axis Ax, which is a design optical axis, is set in the image projection apparatus 3, and the optical component housing 35 holds the devices 31 to 33 described above and the field lens 341 at predetermined positions on the illumination light axis Ax. Note that the light source 30, the light modulation elements 343, and the projection optical device 36 are disposed at predetermined positions on the illumination light axis Ax.

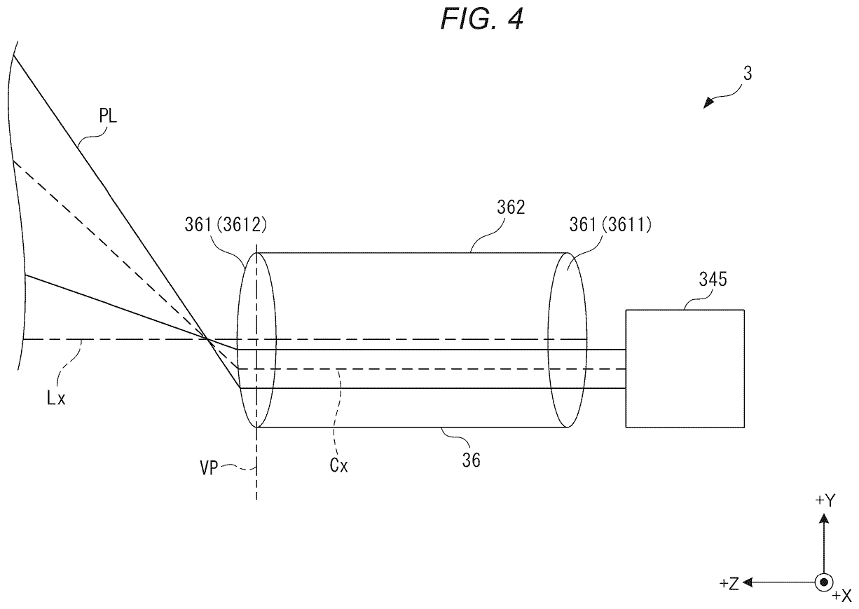

FIG. 4 is a schematic diagram illustrating a light path of the image light PL incident from the color combining element 345 and projected by the projection optical device 36. Note that in FIG. 4, the light path of the image light transmitted through the projection optical device 36 is linearly illustrated, but the actual light path of the image light is refracted inside the projection optical device 36 by the plurality of lenses 361.

The projection optical device 36 projects the image light incident from the image forming device 34 onto the projection target surface in an enlarged manner. As shown in FIG. 4, the projection optical device 36 has a plurality of lenses 361 and a mirror barrel 362 that houses the plurality of lenses 361.

The plurality of lenses 361 includes a rear lens 3611 and a front lens 3612.

The rear lens 3611 is a lens located closest to the light incident side among the plurality of lenses 361, and is a lens on which image light emitted from the color combining element 345 is incident.

The front lens 3612 is a lens located closest to the light exit side among the plurality of lenses 361, and is a lens that projects the image light transmitted through the projection optical device 36. The lens optical axis Lx of the front lens 3612 is deviated from the central axis Cx of the image light PL incident on the front lens 3612. In other words, the lens optical axis Lx of the front lens 3612 is deviated from the central axis Cx of the image light PL. Further, the front lens 3612 projects the image light PL deviated in a direction opposite to the direction in which the central axis Cx is positioned with respect to the lens optical axis Lx. That is, when a direction along the lens optical axis Lx of the front lens 3612 is defined as a first direction and a direction orthogonal to the first direction is defined as a second direction, the projection optical device 36 projects the image light PL such that the projection range of the image light PL on a plane moves in the second direction as moving in the first direction.

In the following description, three directions perpendicular to one another are defined as a +X direction, a +Y direction, and a +Z direction. The +Z direction is defined as a direction parallel to the lens optical axis Lx of the front lens 3612 and is a direction in which the image light PL passes through the front lens 3612. The +Y direction is defined as a direction orthogonal to the +Z direction and opposite to the direction toward the intersection position between the front lens 3612 and the central axis Cx of the image light PL. The +X direction is defined as a left direction when viewed along the +Z direction such that the +Y direction is the upward direction.

Further, although not shown in the drawings, an opposite direction to the +X direction is defined as a −X direction, an opposite direction to the +Y direction is defined as a −Y direction, and an opposite direction to the +Z direction is defined as a −Z direction. Further, an axis along the +X direction is defined as an X axis, an axis along the +Y direction is defined as a Y axis, and an axis along the +Z direction is defined as a Z axis.

In the present embodiment, since the central axis Cx of the image light PL in the front lens 3612 is located at the −Y direction side with respect to the lens optical axis Lx of the front lens 3612, the front lens 3612 projects the image light PL in the +Z direction with a deviation toward the +Y direction. The +Z direction corresponds to a first direction, the +Y direction corresponds to a second direction, and the −Y direction in which the central axis Cx of the front lens 3612 is located with respect to the lens optical axis Lx corresponds to a direction opposite to the second direction.

### Configuration of Inner Surface in Front Surface

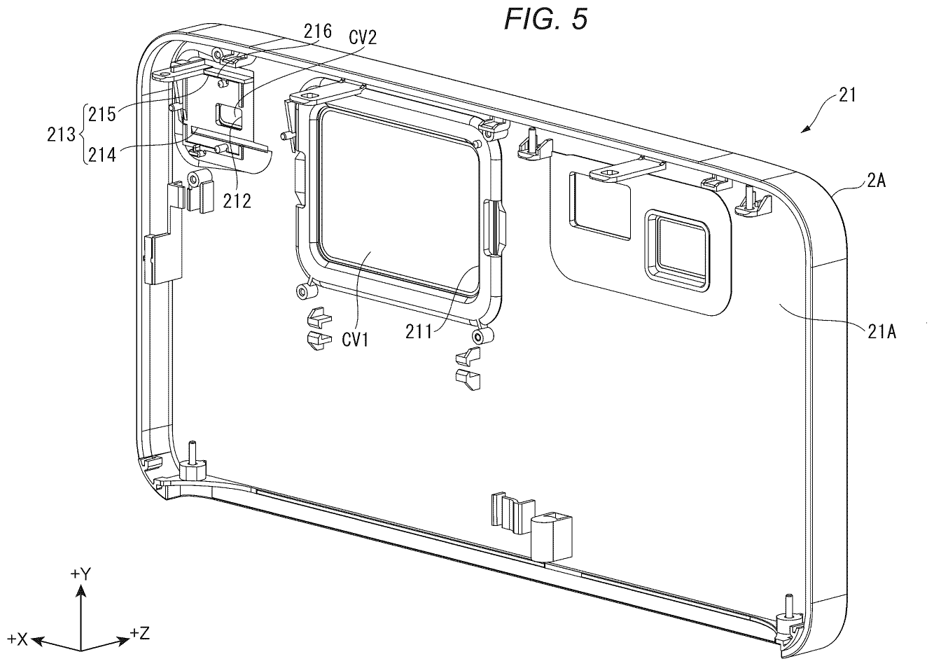

FIG. 5 is a perspective view showing an inner surface 21A of the front surface 21. That is, FIG. 5 is a perspective view illustrating the front surface 21 viewed from the −Z direction.

In addition to the projection port 211, the passage port 212, and the covers CV1, CV2 described above, the front surface 21 includes an attachment portion 213 disposed around the passage port 212 as illustrated in FIG. 5.

The ranging device 4A described later is attached to the attachment portion 213. The attachment portion 213 includes a groove 214 and a projecting portion 215.

The groove 214 is provided in the −Y direction to the passage port 212. The groove 214 is recessed in the +Z direction from an inner surface 21A facing to the −Z direction in the front surface 21 and extends along the X axis. An end portion in the −Y direction of a substrate 41A described later of the ranging device 4A is inserted into the groove 214. An inner surface of the groove 214 is inclined with respect to the X-Y plane so that a point on the inner surface moves toward the +Z direction as the point moves toward the −Y direction.

The projecting portion 215 is located at the +Y direction side with respect to the passage port 212 and projects toward the −Z direction from the inner surface 21A. A surface of the projecting portion 215 at the −Z direction side is a support surface 216 that is in contact with a +Y-direction side end portion of the substrate 41A described later to support the substrate 41A.

The support surface 216 is inclined with respect to the X-Y plane so that a point on the support surface 216 moves toward the +Z direction as the point moves toward the −Y direction. An extension surface of the support surface 216 and an extension surface of the inner surface of the groove 214 substantially coincide with each other.

Further, although not shown in the drawings, the inner surface 21A has a fixation portion to which a fixation member 6 for fixing the ranging device 4A described later is fixed.

### Configuration of Ranging Device

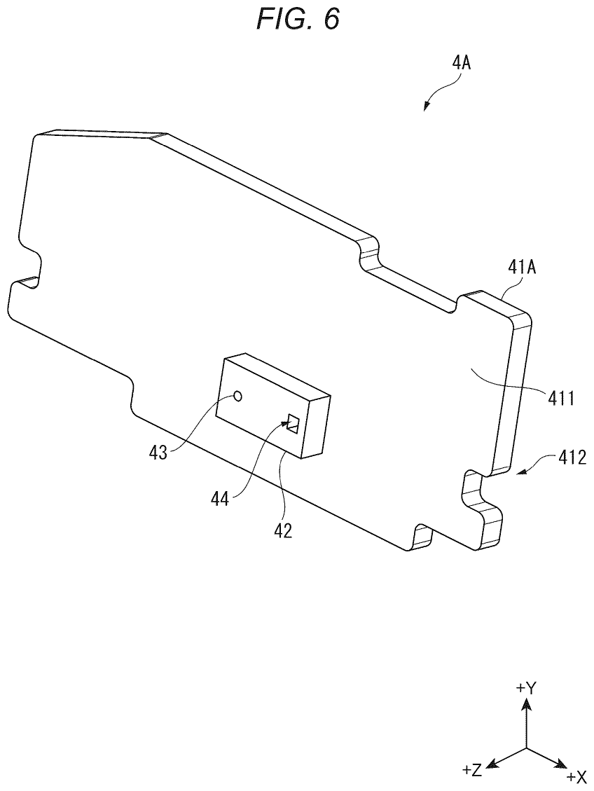

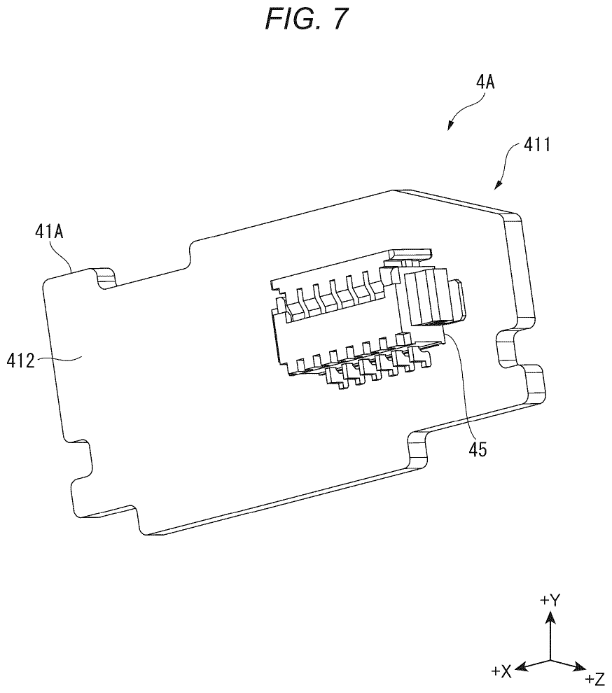

FIG. 6 is a perspective view showing the ranging device 4A viewed from the +Z direction, and FIG. 7 is a perspective view showing the ranging device 4A viewed from the −Z direction.

The ranging device 4A measures a distance to the projection target surface. When an object is disposed between the projector 1A and the projection target surface, the ranging device 4A measures the distance between the projector 1A and the object. The ranging device 4A includes the substrate 41A and the sensor 42 as shown in FIG. 6, and further includes a connector 45 as shown in FIG. 7.

As shown in FIGS. 6 and 7, the substrate 41A is a printed circuit board formed in a substantially rectangular shape elongated along the X axis. The substrate 41A has a first surface 411 and a second surface 412.

The first surface 411 is a surface facing to the +Z direction. As shown in FIG. 6, the sensor 42 is mounted on the first surface 411.

The sensor 42 is disposed in a substantially central portion of the first surface 411 on the X axis, and is disposed at the −Y direction side from the center of the first surface 411 on the Y axis. The sensor 42 includes a light emitting element 43 and a light receiving element 44.

The light emitting element 43 emits the detection light for measuring the distance described above. Particularly, the light emitting element 43 emits the detection light to a predetermined irradiation range centered on a direction passing through the light emitting element 43 and parallel to a line perpendicular to the first surface 411. That is, an exit surface of the light emitting element 43, the exit surface emitting the detection light, is parallel to the first surface 411. In the present embodiment, the light emitting element 43 performs irradiation with the infrared light as the detection light, and the irradiation range of the detection light is set to the same range as the projection range of the image light, or is set to a range which includes the projection range of the image light, and is larger than the projection range.

The light receiving element 44 receives the detection light which is emitted from the light emitting element 43 and is then reflected by the projection target surface or the object described above. The light receiving range of the detection light by the light receiving element 44 is set to overlap the irradiation range of the detection light by the light emitting element 43. That is, a light receiving surface which is provided to the light receiving element 44, and receives the detection light, is parallel to the first surface 411. Note that similarly to the irradiation range of the detection light, the light receiving range of the light receiving element is set to the same range as the projection range of the image light, or is set to a range which includes the projection range of the image light and is larger than the projection range.

As shown in FIG. 7, the second surface 412 is a surface which is opposite to the first surface 411 and faces to the −Z direction. The second surface 412 is provided with the connector 45 and is in contact with pressing members 5 described later.

The connector 45 is mounted on a portion at the −X direction side in the second surface 412. The connector 45 is coupled to the control device described above via wiring lines (not shown). The connector 45 is supplied with electrical power from the control device, and in addition, the connector 45 outputs a signal representing a detection result of the sensor 42 to the control device described above.

Such a ranging device 4A is fixed to the inner surface 21A of the front surface 21 with the fixation member 6 via the pressing members 5.

### Fixation Structure of Ranging Device

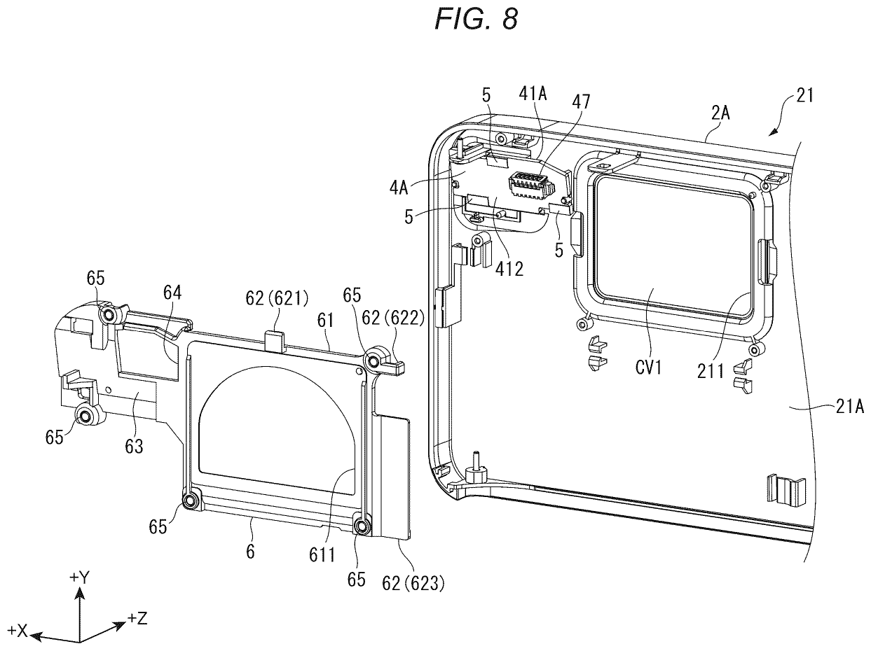

FIG. 8 is a perspective view showing a fixation structure for fixing the ranging device 4A to the inner surface 21A of the front surface 21. That is, FIG. 8 is an exploded perspective view illustrating the pressing members 5 and the fixation member 6 fixed to the inner surface 21A.

In addition to the configuration described above, as shown in FIG. 8, the projector 1A further includes the pressing members 5 that press the substrate 41A of the ranging device 4A toward the inner surface 21A, and the fixation member 6 that fixes the substrate 41A to the inner surface 21A.

### Configuration of Pressing Member

The pressing members 5 are interposed between the substrate 41A and the fixation member 6, and press the substrate 41A toward the cover CV2 provided to the passage port 212. The pressing members 5 are each an elastic member such as a cushion or rubber, and when the fixation member 6 in contact with the pressing members 5 is fixed to the inner surface 21A, the pressing members 5 press the substrate 41A in the +Z direction in which the cover CV2 is positioned with respect to the substrate 41A. Note that in the present embodiment, three pressing members 5 are provided to a surface of the fixation member 6, the surface facing the second surface 412, so as to correspond to a circumferential edge of the second surface 412. However, this is not a limitation, and the positions and the number of the pressing members 5 can appropriately be changed. For example, the pressing members 5 may be disposed on the second surface 412 by pasting or the like.

### Configuration of Fixation Member

The fixation member 6 fixes the pressing members 5 in a state of having contact with the substrate 41A. Particularly, the fixation member 6 presses the substrate 41A via the pressing members 5 to fix the ranging device 4A to the inner surface 21A. The fixation member 6 is a frame including a frame portion 61, a guide portion 62, a support portion 63, an opening 64, and fixation portions 65.

The frame portion 61 is in contact with the inner surface 21A of the front surface 21 and surrounds the projection port 211. Specifically, when the fixation member 6 is fixed to the inner surface 21A, the frame portion 61 is interposed between the inner surface 21A and the projection optical device 36 and covers the projection port 211 from the −Z direction. The frame portion 61 is formed in a rectangular shape having an opening 611 having a semicircular shape when viewed from the −Z direction.

The image light emitted from the projection optical device 36 passes through the opening 611. The image light having passed through the opening 611 is projected to the outside of the projector 1A through the projection port 211.

The guide portion 62 is provided to the frame portion 61, guides wiring to be coupled to the connector 45 of the substrate 41A, and locks the wiring. In the present embodiment, three guide portions 62 are provided to the frame portion 61. The three guide portions 62 include a first guide portion 621, a second guide portion 622, and a third guide portion 623.

The first guide portion 621 protrudes toward the +Y direction from the center on the X axis of an end portion in the +Y direction of the frame portion 61.

The second guide portion 622 protrudes toward the −X direction from a corner portion at the −X direction side and the +Y direction side of the frame portion 61.

The third guide portion 623 is disposed in a portion at the −Y direction side in an end portion at the −X direction side of the frame portion 61, and protrudes toward the −X direction.

The guide portions 621 to 623 can guide the wiring to be coupled to the connector 45. Besides the above, by the guide portions 621 to 623 locking the wiring, the arrangement state of the wiring avoiding the projection port 211 and the projection optical device 36 can be maintained, and the wiring can be prevented from moving around in the exterior housing 2A.

The support portion 63 is a flat plate-shaped portion provided integrally with the frame portion 61 at the +X direction side with respect to the frame portion 61. The support portion 63 supports the pressing members 5 having contact with the substrate 41A. Particularly, when the fixation member 6 is fixed to the inner surface 21A, the support portion 63 fixes the substrate 41A to the inner surface 21A via the pressing members 5.

The opening 64 is a through opening penetrating the support portion 63 along the Z axis. The opening 64 is provided in the support portion 63 in accordance with the position of the connector 45. The opening 64 is an opening for exposing the connector 45. Due to such an opening 64, when the substrate 41A of the ranging device 4A is fixed with the fixation member 6, it becomes possible to couple the wiring to the connector 45 from the outside of the fixation member 6.

The fixation portions 65 are portions for fixing the fixation member 6 to the inner surface 21A. In the present embodiment, a plurality of fixation portions 65 is holes which are provided on a circumferential edge of the fixation member 6, and penetrate the fixation member 6 along the Z axis. By a fixture such as a screw inserted through each of the fixation portions 65 along the +Z direction being fixed to the inner surface 21A, the fixation member 6 is fixed to the inner surface 21A, and by extension, the ranging device 4A is fixed to the inner surface 21A.

### Arrangement of Substrate

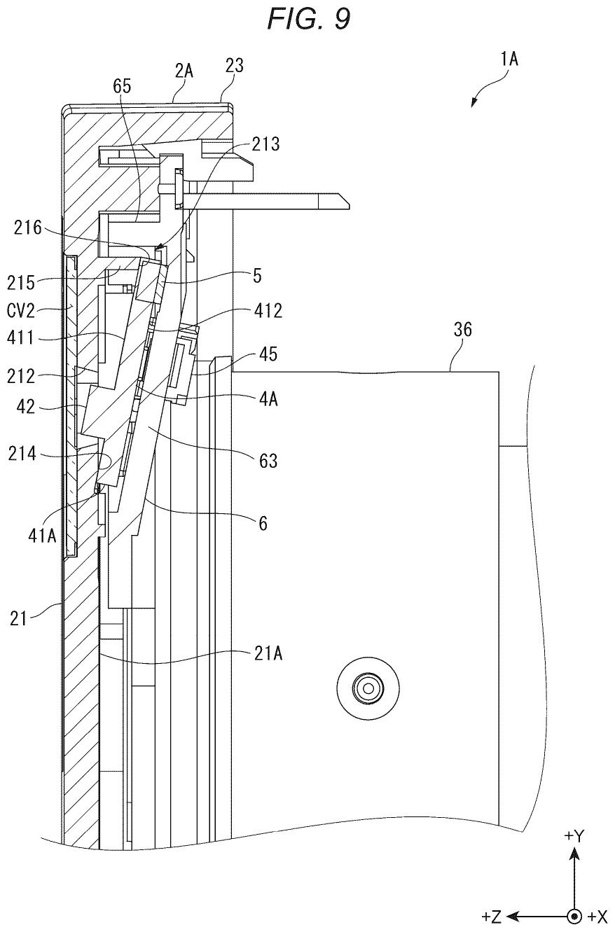

FIG. 9 shows a cross-sectional surface of the projector 1A along a Y-Z plane. Particularly, FIG. 9 is a diagram showing a cross-sectional surface of the exterior housing 2A, the ranging device 4A, the pressing members 5, and the fixation member 6 along the Y-Z plane.

When the fixation member 6 is fixed to the inner surface 21A, the substrate 41A of the ranging device 4A is pressed in the +Z direction toward the cover CV2 by the pressing members 5 in contact with the fixation member 6.

Here, the end portion at the −Y direction side in the substrate 41A is disposed in the groove 214 recessed in the +Z direction from the inner surface 21A, and the end portion at the +Y direction side in the substrate 41A is in contact with the support surface 216 of the projecting portion 215 projecting in the −Z direction from the inner surface 21A. That is, the first surface 411 of the substrate 41A is in contact with each of the inner surface of the groove 214 and the support surface 216.

Therefore, the substrate 41A is disposed to be inclined with respect to the X-Y plane orthogonal to the Z axis. That is, the substrate 41A is disposed to be inclined with respect to a virtual plane VP orthogonal to the lens optical axis Lx of the front lens 3612. Specifically, the substrate 41A is inclined so that a point on the substrate 41A approaches the inner surface 21A of the front surface 21 as the point moves toward the −Y direction which is an opposite direction to the second direction, and the point gets away from the inner surface 21A of the front surface 21 as the point moves toward the +Y direction which is the second direction. Therefore, the substrate 41A is fixed such that the first surface 411 of the substrate 41A faces to the +Y direction and the +Z direction.

By fixing the substrate 41A in this manner, it is possible to make it easy to make the irradiation range of the detection light emitted from the light emitting element 43 of the sensor 42 mounted on the first surface 411 coincide with the projection range of the image light obliquely projected in the +Y direction and the +Z direction from the projection optical device 36. Further, accordingly, it is possible to make it easy to make the light receiving range of the detection light received by the light receiving element 44 of the sensor 42 coincide with the projection range of the image light.

Accordingly, the detection accuracy of the detection light can be improved, and by extension, the ranging accuracy by the ranging device 4A can be improved.

### Advantages of First Embodiment

The projector 1A according to the present embodiment described above provides the following advantages.

The projector 1A includes the external housing 2A, the projection optical device 36, the cover CV2, and the ranging device 4A. The exterior housing 2A has the front surface 21 provided with each of the projection port 211 and the passage port 212. The front surface 21 corresponds to a first surface. The projection optical device 36 projects the image light PL through the projection port 211. The cover CV2 has the light transmissive property, and is disposed so as to correspond to the passage port 212. The ranging device 4A emits and receives the detection light via the cover CV2.

The projection optical device 36 includes the front lens 3612 located at the exit side of the image light. When a direction along the lens optical axis Lx of the front lens 3612 is defined as the +Z direction and a direction orthogonal to the +Z direction is defined as the +Y direction, the projection optical device 36 projects the image light PL such that the projection range of the image light PL on a plane moves toward the +Y direction as moving toward the +Z direction. That is, the projection optical device 36 projects the image light PL so as to be deviated in the +Y direction with respect to the lens optical axis LX. Note that the +Z direction corresponds to the first direction, and the +Y direction corresponds to the second direction.

The ranging device 4A includes the substrate 41A and the sensor 42 disposed on the substrate 41A.

The sensor 42 includes the light emitting element 43 that emits the detection light and the light receiving element 44 that receives the detection light emitted from the light emitting element 43.

The substrate 41A is disposed to be inclined with respect to the virtual plane VP orthogonal to the lens optical axis Lx about the X axis along the +X direction crossing the +Z direction and the +Y direction so that the detection light emitted from the light emitting element 43 is directed to the projection range of the image light by the projection optical device 36. The +X direction or the −X direction corresponds to a third direction, and the X axis corresponds to an axis along the third direction. That is, the substrate 41A is inclined with respect to the virtual plane VP orthogonal to the lens optical axis Lx such that a point on the substrate 41A approaches the inner surface 21A as the point moves toward the −Y direction and gets away from the inner surface 21A as the point moves toward the +Y direction.

According to such a configuration, it is possible to make it easy to point the first surface 411 provided with the sensor 42 to the projection direction of the image light by the projection optical device 36 on the substrate 41A. Accordingly, it is possible to make it easy to overlap the irradiation range of the detection light from the light emitting element 43 with the irradiation range of the image light, and in addition, it is possible to make it easy to overlap the light receiving range of the detection light by the light receiving element 44 with the irradiation range of the image light. Accordingly, it is possible to improve the ranging accuracy by the ranging device 4A.

In the projector 1A, the sensor 42 is disposed at the −Y direction side from the center in the +Y direction on the substrate 41A.

According to such a configuration, it is possible to dispose the sensor 42 provided to the substrate 41A inclined with respect to the virtual plane VP described above at a position close to the cover CV2. Accordingly, since the distance between the cover CV2 and the sensor 42 can be shortened, it is possible to prevent a part of the detection light emitted from the light emitting element 43 from being reflected by the inner surface of the cover CV2 to reach the light receiving element 44. Accordingly, it is possible to improve the ranging accuracy by the ranging device 4A.

In the projector 1A, the exterior housing 2A has the groove 214 and the support surface 216. The groove 214 is provided to the inner surface 21A of the exterior housing 2A. In the groove 214, the end portion in the −Y direction side of the substrate 41A is disposed. The support surface 216 supports the +Y-direction side portion of the substrate 41A.

According to such configuration, it is possible to make it easy to arrange the first surface 411 of the substrate 41A on which the sensor 42 is disposed in a state of being inclined with respect to the virtual plane VP described above by the groove 214 and the support surface 216. Accordingly, it is possible to make it easy to dispose the sensor 42 at a position close to the cover CV2.

The projector 1A includes the pressing members 5 and the fixation member 6. The pressing members 5 press the substrate 41A toward the cover CV2. The fixation member 6 fixes the pressing members 5 in a state of having contact with the substrate 41A.

According to such a configuration, the substrate 41A can be fixed with the pressing members 5 and the fixation member 6. Accordingly, the position of the sensor 42 can be maintained.

In the projector 1A, the fixation member 6 which is a frame includes the frame portion 61 and the support portion 63. The frame portion 61 is in contact with the inner surface 21A of the exterior housing 2A and surrounds the projection port 211. The support portion 63 supports the pressing members 5.

According to such a configuration, the projection port 211 can be surrounded by the frame portion 61. Accordingly, it is possible to prevent light from leaking from the periphery of the projection port 211 and to make it difficult to visually recognize the inside of the exterior housing 2A from the periphery of the projection port 211. In addition, by the support portion 63 supporting the pressing members 5, the pressing members 5 can stably press the substrate 41A toward the cover CV2.

In the projector 1A, the substrate 41A includes the connector 45. The fixation member 6, which is a frame, has an opening 64 from which the connector 45 is exposed.

According to such a configuration, since the connector 45 provided to the substrate 41A is exposed through the opening 64, it is possible to make it easy to achieve the wiring to the connector 45. Accordingly, the assembling step of the ranging device 4A can be simplified.

In the projector 1A, the fixation member 6 which is a frame includes the guide portions 62 which are provided to the frame portion 61 and guides the wiring to be coupled to the connector 45.

According to such a configuration, it is possible to make it easy to couple the wiring to the connector 45 with the guide portions 62, and in addition, the wiring coupled to the connector 45 can be prevented from moving around in the exterior housing 2A.

In the projector 1A, the cover CV2 is provided to the exterior housing 2A.

According to such a configuration, the passage port 212 can be sealed with the cover CV2 disposed in accordance with the passage port 212. Accordingly, since it is possible to prevent the intrusion of dust into the exterior housing 2A through the passage port 212, it is possible to improve the dust resistance of the exterior housing 2A and, by extension, the projector 1A.

In the projector 1A, the light emitting element 43 is a light emitting element that emits infrared light.

According to such a configuration, it is possible to make it difficult for the user to recognize the detection light.

In the projector 1A, the center C2 of the passage port 212 is located at the +Y direction side of the center C1 of the projection port 211.

According to such a configuration, it is possible to make it easy to make the irradiation range of the detection light emitted from the passage port 212 coincide with the projection range of the image light projected from the projection optical device 36 with the deviation toward the +Y direction. Accordingly, it is possible to improve the ranging accuracy by the ranging device 4A.

### Second Embodiment

Then, a second embodiment of the present disclosure will be described.

A projector according to the present embodiment has substantially the same configuration as that of the projector 1A according to the first embodiment, but differs therefrom in the fixation method of the ranging device. Note that in the following description, the same or substantially the same portions as the portions having already been described are denoted by the same reference numerals, and the description thereof will be omitted.

### Schematic Configuration of Projector

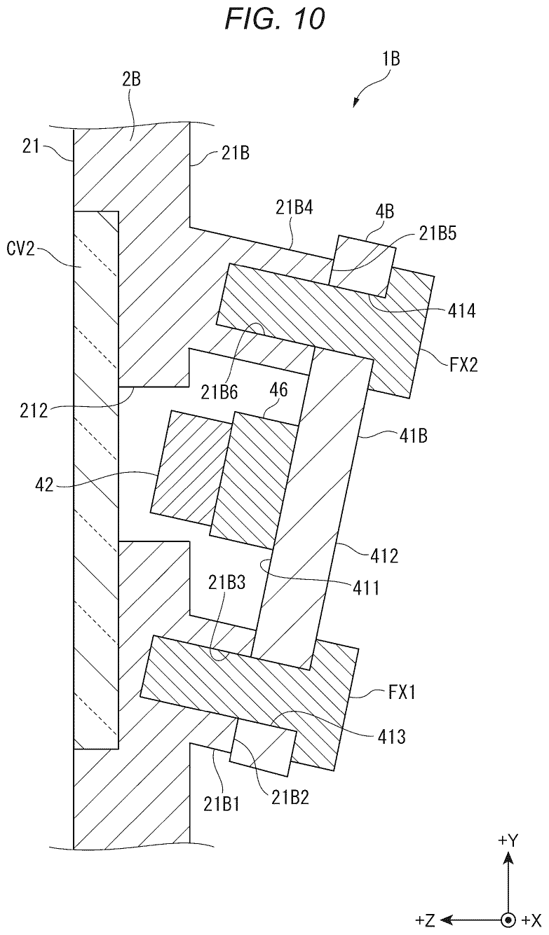

FIG. 10 is a diagram illustrating a cross-sectional surface along the Y-Z plane of an exterior housing 2B and a ranging device 4B provided to the projector 1B according to the present embodiment.

The projector 1B according to the present embodiment has substantially the same configuration and function as those of the projector 1A according to the first embodiment except that the projector 1B includes the exterior housing 2B and the ranging device 4B shown in FIG. 10 instead of the exterior housing 2A, the ranging device 4A, the pressing members 5, and the fixation member 6.

### Configuration of Exterior Housing

The exterior housing 2B has substantially the same configuration as that of the exterior housing 2A according to the first embodiment except that the exterior housing 2B has an inner surface 21B instead of the inner surface 21A. That is, in addition to the front surface 21 and the inner surface 21B of the front surface 21, the exterior housing 2B includes the back surface 22, the top surface 23, the bottom surface 24, the left side surface 25, and the right side surface 26 (not shown).

Further, the exterior housing 2B includes two holding portions 21B1, 21B4 provided to the inner surface 21B. The two holding portions 21B1, 21B4 hold the substrate 41B of the ranging device 4B in a state of being inclined with respect to the virtual plane VP orthogonal to the lens optical axis Lx described above.

Out of the two holding portions 21B1, 21B4, the first holding portion 21B1 is disposed at the −Y direction side with respect to the passage port 212, and the second holding portion 21B4 is disposed at the +Y direction side with respect to the passage port 212. The holding portions 21B1, 21B4 protrude from the inner surface 21B toward the −Y direction and the −Z direction.

The surface of the first holding portion 21B1 facing to the −Z direction is a support surface 21B2 that supports the substrate 41B of the ranging device 4B, and the surface of the second holding portion 21B4 facing to the −Z direction is a support surface 21B5 that supports the substrate 41B.

In the present embodiment, the protruding dimension of the second holding portion 21B4 from the inner surface 21B is larger than the protruding dimension of the first holding portion 21B1 from the inner surface 21B, and the support surface 21B5 is located at the −Z direction side of the support surface 21B2.

Each of the support surfaces 21B2, 21B5 is inclined so that a point on the support surface moves toward the +Z direction to come closer to the inner surface 21B as the point moves toward the −Y direction. In other words, each of the support surfaces 21B2, 21B5 is inclined so that a point on the support surface moves toward the −Z direction to get away from the inner surface 21B as the point moves toward the +Y direction. An extension surface of the support surface 21B2 and an extension surface of the support surface 21B5 coincide with each other.

The support surface 21B2 is provided with a fixation portion 21B3 to which the fixture FX1 is fixed, and the support surface 21B5 is provided with a fixation portion 21B6 to which the fixture FX2 is fixed. In the present embodiment, the fixtures FX1, FX2 are screws.

### Configuration of Ranging Device

The ranging device 4B has substantially the same configuration and function as those of the ranging device 4A according to the first embodiment except that the ranging device 4B includes a substrate 41B and a position adjustment member 46 instead of the substrate 41A. That is, the ranging device 4B includes the substrate 41B, the sensor 42, the position adjustment member 46, and the connector 45 which is not shown in FIG. 10.

Similarly to the substrate 41A, the substrate 41B is formed in a rectangular shape when viewed from the −Z direction. The substrate 41B includes the first surface 411 facing to the +Z direction, the second surface 412 facing to the −Z direction, and in addition, includes through openings 413, 414 penetrating the substrate 41B in a direction from the second surface 412 toward the first surface 411.

The through opening 413 is disposed so as to correspond to the fixation portion 21B3 of the first holding portion 21B1, and the through opening 414 is disposed so as to correspond to the fixation portion 21B6 of the second holding portion 21B4. The fixture FX1 inserted through the through opening 413 from the −Z direction is fixed to the fixation portion 21B3, and the fixture FX2 inserted through the through opening 414 from the −Z direction is fixed to the fixation portion 21B6, whereby the substrate 41B is held by the holding portions 21B1, 21B4. Accordingly, the substrate 41B is held such that the first surface 411 provided with the sensor 42 in the substrate 41B is in the state of being inclined with respect to the virtual plane VP orthogonal to the lens optical axis Lx.

The position adjustment member 46 is disposed on the first surface 411 of the substrate 41B. Specifically, the position adjustment member 46 is a substrate that is disposed between the first surface 411 and the sensor 42 and functions as a pedestal that adjusts the position of the sensor 42. By providing such a position adjustment member 46, the sensor 42 can be brought closer to the cover CV2, and reflection of the detection light on a surface facing to the −Z direction in the cover CV2 can be prevented.

### Advantages of Second Embodiment

The projector 1B according to the present embodiment described hereinabove provides the following advantages besides substantially the same advantages as those provided by the projector 1A according to the first embodiment.

In the projector 1B, the exterior housing 2B includes the holding portions 21B1, 21B4 that hold the substrate 41B in the state of being inclined with respect to the virtual plane VP described above.

According to such a configuration, since the exterior housing 2B has the holding portions 21B1, 21B4, it is unnecessary to separately provide a member for holding the substrate 41B. Therefore, it is possible to suppress an increase in the number of components of the projector 1B including the substrate 41B inclined with respect to the virtual plane VP described above.

### Third Embodiment

Then, a third embodiment of the present disclosure will be described.

The projector according to the present embodiment has substantially the same configuration as that of the projector 1A according to the first embodiment, but is different in that a ranging device unitized with a cover is fixed to a support member that supports the image projection apparatus 3. Note that in the following description, the same or substantially the same portions as the portions having already been described are denoted by the same reference numerals, and the description thereof will be omitted.

### Schematic Configuration of Projector

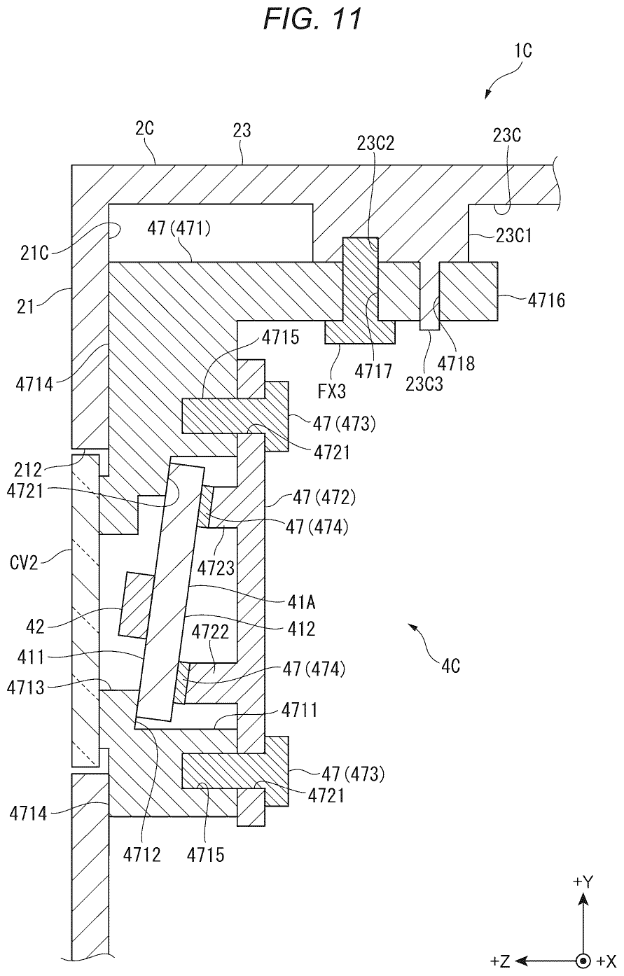

FIG. 11 is a diagram illustrating a cross-sectional surface along the Y-Z plane of an exterior housing 2C and a ranging device 4C provided to the projector 1C according to the present embodiment.

The projector 1C according to the present embodiment has substantially the same configuration and function as those of the projector 1A according to the first embodiment except that the projector 1C includes the exterior housing 2C and the ranging device 4C shown in FIG. 11 instead of the exterior housing 2A and the ranging device 4A.

### Configuration of Exterior Housing

The exterior housing 2C has substantially the same configuration as that of the exterior housing 2A according to the first embodiment except that the inner surface 21C of the front surface 21 is provided instead of the inner surface 21A of the front surface 21, and an inner surface 23C of the top surface 23 is further provided. That is, the exterior housing 2C includes the back surface 22, the bottom surface 24, the left side surface 25, and the right side surface 26 (not shown) in addition to the front surface 21, the inner surface 21C of the front surface 21, the top surface 23, and the inner surface 23C of the top surface 23.

Note that unlike the inner surface 21A related to the first embodiment and the inner surface 21B related to the second embodiment, the inner surface 21C is not provided with the attachment portion 213 and the holding portions 21B1, 21B4, and is formed substantially flat along the X-Y plane. A contact surface 4714 of the ranging device 4C comes into contact with the inner surface 21C.

Further, the exterior housing 2C has an attachment portion 23C1 disposed on the inner surface 23C.

The attachment portion 23C1 protrudes from the inner surface 23C toward the −Y direction. A housing 47 described later of the ranging device 4C is attached to the attachment portion 23C1. The attachment portion 23C1 includes a fixation portion 23C2 and a positioning portion 23C3.

A fixture FX3 for fixing the housing 47 is fixed to the fixation portion 23C2. The fixture FX3 is, for example, a screw inserted through a part of the housing 47, and the fixation portion 23C2 is a screw hole to which the fixture FX3 is fixed.

The positioning portion 23C3 is engaged with the housing 47 to position the housing 47. In the present embodiment, the positioning portion 23C3 is a positioning protrusion inserted into the housing 47. However, when the housing 47 has a positioning protrusion, the positioning portion 23C3 may be a positioning hole into which the positioning protrusion is inserted.

### Configuration of Ranging Device

The ranging device 4C includes the housing 47 in addition to substantially the same configuration as the ranging device 4A related to the first embodiment, and has substantially the same function as the ranging device 4A. That is, the ranging device 4C includes the substrate 41A, the sensor 42, the connector 45, and the housing 47, and is unitized with the housing 47. Note that the ranging device 4C may include the position adjustment member 46 interposed between the first surface 411 of the substrate 41A and the sensor 42.

The housing 47 houses the substrate 41A and is attached to the attachment portion 23C1. The housing 47 includes a first housing 471, a second housing 472, fixtures 473, and pressing members 474, in which the first and second housings 471, 472 hold the substrate 41A therebetween on the Z axis.

Note that the directions shown in the following description of the constituents of the housing 47 are directions when the ranging device 4C is attached to the attachment portion 23C1 of the exterior housing 2C.

### Configuration of First Housing

The first housing 471 includes a recess 4711, a support surface 4712, a communication port 4713, a contact surface 4714, fixation portions 4715, and an attachment portion 4716.

The recess 4711 is a concave portion that is recessed toward the +Z direction from a surface at the −Z direction side of the first housing 471. The substrate 41A is disposed in the recess 4711 from the −Z direction.

The support surface 4712 is a part of a bottom surface of the recess 4711 and is in contact with the first surface 411 of the substrate 41A disposed in the recess 4711. Similarly to the support surfaces 21B2 and 21B5 related to the second embodiment, the support surface 4712 is inclined so that a point on the support surface 4712 moves toward the +Z direction to come closer to the inner surface 21C as the point moves toward the −Y direction. In other words, the support surface 4712 is inclined so that a point on the support surface 4712 moves toward the −Z direction to get away from the inner surface 21C as the point moves toward the +Y direction. By the first surface 411 comes into contact with the support surface 4712, the substrate 41A is supported so as to be in the state in which the first surface 411 of the substrate 41A is inclined with respect to the virtual plane VP orthogonal to the lens optical axis Lx and faces to the +Y direction and the +Z direction.

The communication port 4713 is an opening that allows a space in the recess 4711 to communicate with a space at the +Z direction side of the first housing 471. The communication port 4713 is disposed corresponding to the sensor 42 of the substrate 41A disposed in the recess 4711, and the detection light emitted from the light emitting element 43 of the sensor 42 and the detection light to be incident on the light receiving element 44 of the sensor 42 pass through the communication port 4713.

The communication port 4713 is closed by the cover CV2 disposed at the +Z direction side with respect to the substrate 41A. That is, the communication port 4713 is closed by the cover CV2 which has a light transmissive property and is fixed to a +Z-direction side surface of the first housing 471. In this way, in the present embodiment, the cover CV2 is provided to the housing 47 of the ranging device 4C.

Note that by attaching the ranging device 4C to the attachment portion 23C1, the cover CV2 is disposed in the passage port 212 provided to the front surface 21. Although not illustrated in the drawings, a gap between the cover CV2 and an inner edge of the passage port 212 may be sealed with a sealing material.

The contact surface 4714 is a surface facing to the +Z direction in the housing 47, and is a surface surrounding the cover CV2 when viewed from the +Z direction. The contact surface 4714 is in contact with the inner surface 21C of the front surface 21.

The fixation portions 4715 are provided to a surface facing the −Z direction in the first housing 471. Particularly, a plurality of fixation portions 4715 is disposed outside the recess 4711 when viewed from the −Z direction. Each of the plurality of fixation portions 4715 is a portion to which the fixture 473 for fixing the second housing 472 to the first housing 471 is fixed. In the present embodiment, the fixture 473 is a screw, and the fixation portion 4715 is a screw hole to which the fixture 473 is fixed.

The attachment portion 4716 is a portion that extends in the −Z direction from an end portion at the +Y direction side in the first housing 471 and is attached to the attachment portion 23C1. The attachment portion 4716 includes a first through opening 4717 and a second through opening 4718. The through openings 4717, 4718 penetrate the attachment portion 4716 along the Y axis.

A part of the fixture FX3 is inserted into the first through opening 4717 along the +Y direction, and the fixture FX3 is fixed to the fixation portion 23C2 of the attachment portion 23C1.

The positioning portion 23C3 is inserted into the second through opening 4718 along the −Y direction.

### Configuration of Second Housing

The second housing 472 is a plate-like member that is combined with the first housing 471 to sandwich the substrate 41A together with the first housing 471 on the Z axis. The second housing 472 includes insertion ports 4721 and protruding portions 4722, 4723.

A plurality of insertion ports 4721 is disposed corresponding to the respective fixation portions 4715. The insertion port 4721 is an opening through which the fixture 473 is inserted along the +Z direction. By the fixture 473 inserted through the insertion port 4721 being fixed to the corresponding fixation portion 4715, the second housing 472 is fixed to the first housing 471.

Each of the protruding portions 4722, 4723 protrudes toward the +Z direction from the surface facing to the +Z direction in the second housing 472, and presses the substrate 41A toward the support surface 4712 via the pressing member 474. The protruding portion 4722 is disposed corresponding to a portion at the −Y direction side in the substrate 41A, and the protruding portion 4723 is disposed corresponding to a portion at the +Y direction side in the substrate 41A.

The end surfaces of the protruding portions 4722, 4723 at the +Z direction side are inclined with respect to the X-Y plane so that a point on the end surface moves toward the +Z direction as the point moves toward the −Y direction. The extension surface of the end surface of the protruding portion 4722 at the +Z direction side substantially coincides with the extension surface of the end surface of the protruding portion 4723 at the +Z direction side. The pressing member 474 is provided to an end surface at the +Z direction side of each of the protruding portions 4722, 4723.

The pressing member 474 is an elastic member similar to the pressing member 5. The pressing member 474 is in contact with the second surface 412 in the substrate 41A. That is, the pressing members 474 are respectively disposed between the protruding portion 4722 and the second surface 412 and between the protruding portion 4723 and the second surface 412.

When the second housing 472 is attached to the first housing 471, the pressing members 474 press the substrate 41A toward the support surface 4712 with the protruding portions 4722, 4723.

By attaching the housing 47 having h such a configuration to the inner surfaces 21C and 23C of the exterior housing 2C, the inclined state of the substrate 41A of the ranging device 4C with respect to the virtual plane VP described above is maintained. Accordingly, it is possible to make it easy to make the irradiation range of the detection light emitted to the outside of the projector 1C through the cover CV2 coincide with the projection range of the image light projected by the projection optical device 36.

### Advantages of Third Embodiment

The projector 1C according to the present embodiment described hereinabove provides the following advantages besides substantially the same advantages as those provided by the projector 1A according to the first embodiment.

In the projector 1C, the ranging device 4C includes the housing 47 that holds the substrate 41A in the state of being inclined with respect to the virtual plane VP described above.

According to such a configuration, since the ranging device 4C is provided with the housing 47 which holds the substrate 41A, the ranging device 4C can be unitized including the housing 47. Accordingly, the ranging device 4C can easily be assembled to the projector 1C.

In the projector 1C, the cover CV2 is provided to the ranging device 4C.

According to configuration, the such a positional relationship between the sensor 42 provided to the substrate 41A and the cover CV2 can be maintained, and in addition, it is possible to make it easy to dispose the sensor 42 at a position close to the cover CV2. Further, since the ranging device 4C having the substrate 41A can be unitized, the assembling property of the projector can be improved.

In the projector 1C, the ranging device 4C is fixed to the fixation portion 23C2 provided to the inner surface 23C of the exterior housing 2C. That is, the ranging device 4C is fixed to the exterior housing 2C.

According to such a configuration, the ranging device 4C can easily be attached to the projector 1C.

### Fourth Embodiment

Then, a fourth embodiment of the present disclosure will be described.

The projector according to the present embodiment has substantially the same configuration as that of the projector 1C according to the third embodiment, but is different in that a ranging device having a housing is fixed to a support member that supports the image projection apparatus. Note that in the following description, the same or substantially the same portions as the portions having already been described are denoted by the same reference numerals, and the description thereof will be omitted.

### Schematic Configuration of Projector

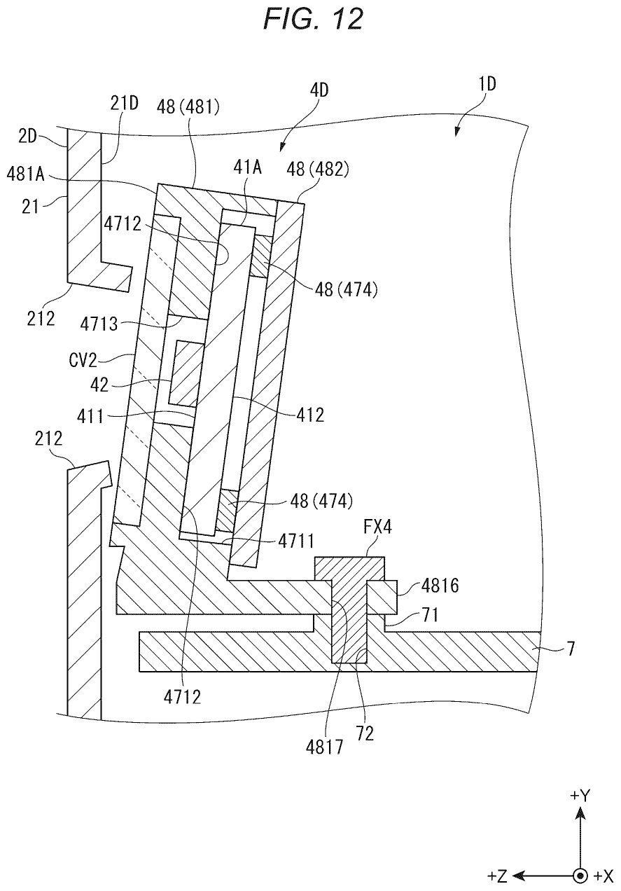

FIG. 12 is a diagram illustrating a cross-sectional surface along the Y-Z plane of an exterior housing 2D, a ranging device 4D, and a support member 7 provided to the projector 1D according to the present embodiment.

The projector 1D according to the present embodiment has substantially the same configuration and function as those of the projector 1C according to the third embodiment except that the projector 1D D includes the exterior housing 2D and the ranging device 4D shown in FIG. 12 instead of the exterior housing 2C and the ranging device 4C, and further includes the support member 7.

### Configuration of Exterior Housing

The exterior housing 2D has substantially the same configuration as that of the exterior housing 2A according to the first embodiment except that the exterior housing 2D has an inner surface 21D instead of the inner surface 21A. That is, in addition to the front surface 21 and the inner surface 21D of the front surface 21, the exterior housing 2D includes the back surface 22, the top surface 23, the bottom surface 24, the left side surface 25, and the right side surface 26 (not shown).

The inner surface 21D has substantially the same configuration as that of the inner surface 21C except that an inner edge of the passage port 212 protrudes in the −Z direction. The protrusion dimension of the inner edge of the passage port 212 toward the −Z direction at a point on the inner edge increases as the point moves toward the +Y direction. This is a configuration for reducing the distance between the inner edge of the passage port 212 and the cover CV2 provided to the ranging device 4D described later.

Note that the inner surface of the passage port 212 is subjected to processing of increasing the surface roughness such as blast processing. Accordingly, diffuse reflection of the detection light on the inner surface is suppressed, and a decrease in the detection accuracy by the ranging device 4D is suppressed.

### Configuration of Support Member

The support member 7 is a base that is disposed in the exterior housing 2D and supports the image projection apparatus 3 described above. Particularly, the support member 7 supports the projection optical device 36.

In addition, the support member 7 includes an attachment portion 71 to which the ranging device 4D is attached. The attachment portion 71 has a fixation portion 72 to which a fixture FX4 for fixing a housing 48 described later of the ranging device 4D is fixed.

In the present embodiment, the fixture FX4 is a screw, and the fixation portion 72 is a screw hole. Then, the housing 48 is fixed to the support member 7 by fixing the fixture FX4 inserted in the −Y direction through a through opening 4817 described later of the housing 48 to the fixation portion 72.

### Configuration of Ranging Device

The ranging device 4D has substantially the same configuration and function as those of the ranging device 4C according to the third embodiment except that the housing 48 is provided instead of the housing 47. That is, the ranging device 4D includes the substrate 41A, the sensor 42, the connector 45, and the housing 48, and is unitized with the housing 48. Note that the ranging device 4D may include the position adjustment member 46 interposed between the first surface 411 of the substrate 41A and the sensor 42.

### Configuration of Housing

The housing 48 houses the substrate 41A and is attached to the support member 7. The housing 48 includes a first housing 481, a second housing 482, and the pressing members 474, and in addition, includes the fixtures 473 not shown in FIG. 12, in which the first and second housings 481, 482 sandwich the substrate 41A therebetween on the Z axis.

Note that the directions shown in the following description of the constituents of the housing 48 are directions when the ranging device 4D is attached to the support member 7.

### Configuration of First Housing

The first housing 481 has substantially the same configuration and function as those of the first housing 471 related to the third embodiment except that the first housing 481 includes an attachment portion 4816 instead of the contact surface 4714 and the attachment portion 4716. In other words, in addition to the recess 4711, the support surface 4712, the communication port 4713, and the attachment portion 4816, the first housing 481 includes a fixation portion 4715 not shown in FIG. 12.

The attachment portion 4816 is a portion that extends in the −Z direction from an end portion at the −Y direction side in the first housing 481, and is attached to the support member 7. The attachment portion 4816 has the through opening 4817.

A part of the fixture FX4 that fixes the housing 48 to the support member 7 is inserted into the through opening 4817 along the −Y direction, and the fixture FX4 is attached to the attachment portion 71 of the support member 7.

Note that when the support member 7 has a positioning protrusion, the attachment portion 4816 may have a positioning hole into which the positioning protrusion is inserted.

In such a first housing 481, a surface 481A facing to the +Z direction is inclined with respect to the X-Y plane. Particularly, the surface 481A is inclined with respect to the X-Y plane so that a point on the surface 481A comes closer to the inner surface 21D as the point moves toward the −Y direction. The cover CV2 that covers the communication port 4713 from the +Z direction is attached to the surface 481A. Therefore, similarly to the surface 481A, the cover CV2 is inclined with respect to the X-Y plane.

### Configuration of Second Housing

The second housing 482 is configured in a flat plate shape. By being fixed to the first housing 481, the second housing 482 sandwiches the substrate 41A arranged to be inclined with respect to the X-Y plane in the recess 4711.

The second housing 482 is disposed substantially in parallel to the substrate 41A, and the pressing members 474 are disposed between a surface facing to the +Z direction in the second housing 482 and the second surface 412 of the substrate 41A. Therefore, when the second housing 482 is fixed to the first housing 481, the substrate 41A is pressed toward the support surface 4712 of the first housing 481 with the pressing members 474. Accordingly, the substrate 41A is kept in the state in which the substrate 41A is inclined with respect to the X-Y plane, and the sensor 42 faces to the +Y direction and the +Z direction.

### Advantages of Fourth Embodiment

The projector 1D according to the present embodiment described hereinabove provides the following advantages besides substantially the same advantages as those provided by the projector 1C according to the third embodiment.

The projector 1D includes the support member 7 that is disposed in the exterior housing 2D and supports the projection optical device 36. The ranging device 4D is fixed to the support member 7.

According to such a configuration, the projection optical device 36 and the ranging device 4D are fixed to the same support member 7. According to this, the projection optical device 36 and the ranging device 4D inclined with respect to the virtual plane VP described above related to the projection optical device 36 can integrally be configured. Accordingly, it is possible to make it easy to adjust the inclination of the substrate 41A with respect to the virtual plane VP described above. Besides the above, even when external force is applied to the projector 1D due to falling or the like of the projector 1D, it is possible to prevent the position of the substrate 41A with respect to the virtual plane VP orthogonal to the lens optical axis Lx related to the projection optical device 36 from being displaced.

### Fifth Embodiment

Then, a fifth embodiment of the present disclosure will be described.

The projector according to the present embodiment has substantially the same configuration as that of the projector 1A according to the first embodiment, but is different in that the substrate constituting the ranging device is arranged to be inclined not only in the +Y direction and the +Z direction, but also in the −X direction and the +Z direction. Note that in the following description, the same or substantially the same portions as the portions having already been described are denoted by the same reference numerals, and the description thereof will be omitted.

### Schematic Configuration of Projector

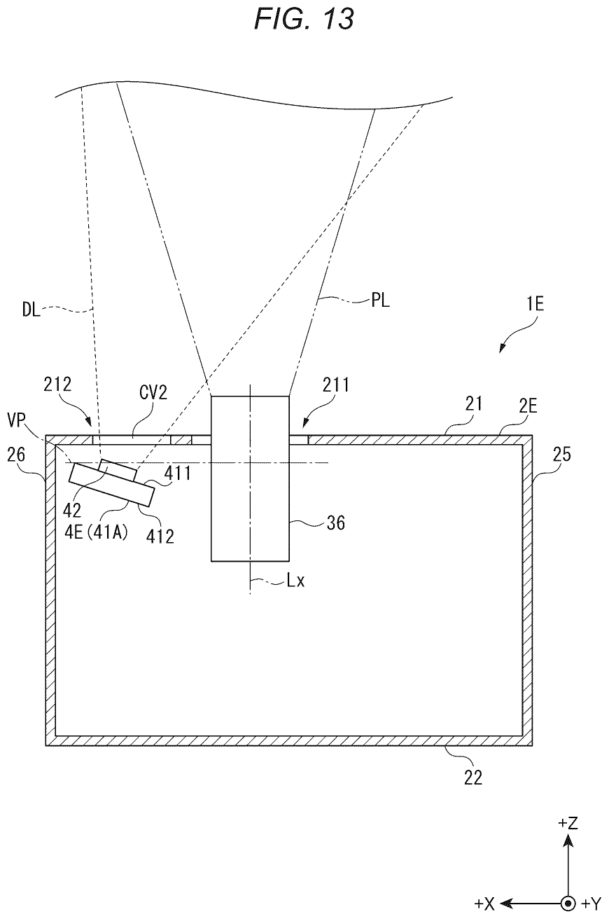

FIG. 13 is a diagram showing an inclined state of the substrate 41A in a projector 1E according to the present embodiment.

As shown in FIG. 13, the projector 1E according to the present embodiment has substantially the same configuration and function as those of any one of the projectors 1A, 1B, 1C, and 1D according to the first to fourth embodiments except that the projector 1E includes an exterior housing 2E and a ranging device 4E instead of the exterior housings 2A, 2B, 2C, and 2D and the ranging devices 4A, 4B, 4C, and 4D.

Note that the exterior housing 2E has substantially the same configuration and function as those of any one of the exterior housings 2A, 2B, 2C, and 2D according to the first to fourth embodiments.

Further, in the projector 1E according to the present embodiment, an end portion at the image light exit side in the projection optical device 36 protrudes to the outside from the projection port 211 of the exterior housing 2E.

### Configuration of Ranging Device

The ranging device 4E includes at least the substrate 41A according to the first embodiment. The substrate 41A is disposed at a distance from the projection optical device 36 in the +X direction so that the end portion at the image light exit side in the projection optical device 36 protruding from the projection port 211 is not included in the irradiation range of the detection light.

Although not shown in the drawings, similarly to the substrates 41A, 41B in the first to fourth embodiments, the substrate 41A related to the ranging device 4E is inclined with respect to the virtual plane VP orthogonal to the lens optical axis Lx so that a point on the substrate 41A approaches the inner surface of the front surface 21 as the point moves toward the −Y direction. That is, the first surface 411 of the substrate 41A is inclined with respect to the X-Y plane so that a point on the first surface 411 approaches the inner surface of the front surface 21 as the point moves toward the −Y direction.

Further, the substrate 41A related to the ranging device 4E is inclined with respect to the virtual plane VP orthogonal to the lens optical axis Lx so that a point on the substrate 41A comes close to the inner surface of the front surface 21 as the point moves toward the +X direction to get away from the projection optical device 36. That is, a point on the first surface 411 of the substrate 41A approaches the inner surface of the front surface 21 as the point moves toward the +X direction. In other words, a point on the first surface 411 of the substrate 41A gets away from the inner surface of the front surface 21 as the point moves toward the −X direction to come closer to the projection optical device 36, and the substrate 41A is inclined with respect to the X-Y plane.

In the substrate 41A arranged as described above, it is possible to make it easy to point the irradiation range of the detection light DL emitted from the light emitting element 43 of the sensor 42 at the projection range of the image light PL projected from the projection optical device 36. Besides the above, in the substrate 41A, it is possible to make it easy to point the light receiving range of the detection light DL received by the light receiving element 44 of sensor 42 at the projection range of the image light PL projected from the projection optical device 36. Accordingly, the detection accuracy by the sensor 42 can be improved, and the ranging accuracy by the ranging device 4E can be improved.

Note that as a holding structure of the substrate 41A in the present embodiment, substantially the same holding structure as the holding structure of the substrate 41A related to the first to fourth embodiments can be adopted.

For example, by adopting the holding structure related to the first embodiment as the holding structure related to the present embodiment, and adjusting angles of the groove 214 and the support surface 216 with respect to the virtual plane VP, the first surface 411 of the substrate 41A can be inclined as described above.

For example, by adopting the holding structure related to the second embodiment as the holding structure related to the present embodiment, and adjusting angles of the support surfaces 21B2, 21B5 with respect to the virtual plane VP, the first surface 411 of the substrate 41A can be inclined as described above.

For example, by adopting the holding structure related to the third embodiment as the holding structure related to the present embodiment, and adjusting an angle of the support surface 4712 with respect to the virtual plane VP, the first surface 411 of the substrate 41A can be inclined as described above.

For example, by adopting the holding structure related to the fourth embodiment as the holding structure related to the present embodiment, and adjusting the angle of the support surface 4712 with respect to the virtual plane VP, or inclining an orientation of a surface at the +Z direction side in the housing 48 toward the projection optical device 36, the first surface 411 of the substrate 41A can be inclined as described above.

### Advantages of Fifth Embodiment

The projector 1E according to the present embodiment described hereinabove provides the following advantages besides substantially the same advantages as those provided by the projector 1A according to the first embodiment.

In the projector 1E, the passage port 212 is disposed at a distance in the +X direction from the projection port 211. In the present embodiment, the +X direction corresponds to a third direction. The substrate 41A has a first surface 411 facing the inner surface of the front surface 21. A point on the first surface 411 approaches the inner surface of the front surface 21 as the point moves toward the +X direction. That is, the substrate 41A is disposed to be inclined such that a point on the first surface 411 approaches the inner surface of the front surface 21 as the point moves toward the +X direction. The first surface 411 corresponds to an opposed surface opposed to the inner surface of the front surface 21 in the substrate 41A.

According to such a configuration, even when the passage port 212 is at a distance in the +X direction from the projection port 211, it is possible to make it easy to make the irradiation range of the detection light coincide with the projection range of the image light. Accordingly, it is possible to improve the ranging accuracy by the ranging device 4E. Not that the same applies to when the passage port 212 is at a distance in the −X direction from the projection port 211.

### Modifications of Embodiments

The present disclosure is not limited to the embodiments described above, and modifications, improvements, and so on within a range in which the object of the present disclosure can be achieved should fall within the scope of the present disclosure.

In each of the embodiments described above, it is assumed that the sensor 42 is disposed in the portion at the −Y direction side in the substrates 41A, 41B. That is, the sensor 42 is disposed in the portion at the −Y direction side with respect to the center in the Y axis of the first surface 411 of the substrate 41A, 41B. However, this is not a limitation, and the position of the sensor 42 on the first surface 411 of the substrate 41A, 41B can appropriately be changed.

In the first embodiment described above, it is assumed that the exterior housing 2A has the groove 214 provided to the inner surface 21A of the front surface 21. However, this is not a limitation, and the groove 214 may be omitted. In this case, the inner surface 21A may be provided with a stopper for stopping the end portion at the −Y direction side in the substrate 41A. As such a stopper, for example, a protruding portion that protrudes from the inner surface 21A to hold the end portion at the −Y direction side in the substrate 41A can be cited.

In the first embodiment described above, it is assumed that the projector 1A includes the pressing members 5 that press the substrate 41A, and in the third and fourth embodiments, it is assumed that the pressing members 474 arranged in the housing 47 are provided. However, this is not a limitation, and when, for example, the substrate 41A is bonded to the support surface 216 and the support surface 4712 with an adhesive or the like, the pressing members 5 may be omitted. In this case, the fixation member 6 can also be omitted.

In the first embodiment described above, it is assumed that the fixation member 6 has the opening 64 from which the connector 45 of the substrate 41A is exposed. However, this is not a limitation, and the fixation member 6 is not required to include the opening 64. In this case, the fixation member 6 may include a passage port through which the wiring to be coupled to the connector 45 passes at a position different from the position where the connector 45 is disposed.

In the first embodiment described above, it is assumed that the fixation member 6 includes the guide portions 62 provided to the frame portion 61. However, this is not a limitation, and the guide portions 62 may be omitted. Further, even when the guide portions 62 are provided to the fixation member 6, the positions and the number of the guide portions 62 may appropriately be changed.

In the embodiments described above, it is assumed that the projectors 1A, 1B, 1C, 1D, and 1E include the cover CV2 provided to the passage port 212. However, this is not a limitation, and the cover CV2 may be omitted. Further, the configuration for holding the cover CV2 is not limited to the exterior housing 2A, 2B or the ranging device 4C, 4D, and may be another configuration.

Further, in the third and fourth embodiments described above, it is assumed that the cover CV2 is attached to the housing 47, 48 of the ranging device 4C, 4D. However, this is not a limitation, and the cover CV2 may be attached to the exterior housing 2C, 2D.

In the embodiments described above, it is assumed that the light emitting element 43 emits infrared light as the detection light. However, this is not a limitation, the detection light may be light in a wavelength band other than the infrared light.

In the embodiments described above, it is assumed that the center C2 of the passage port 212 on the Y axis described later is located at the +Y direction side from the center C1 of the projection port 211 on the Y axis. However, this is not a limitation, and the position of the center C2 of the passage port 212 on the Y axis may be the same as the position of the center C1 of the projection port 211 on the Y axis, or may be located at the −Y direction side of the center C1 of the projection port 211 on the Y axis.

In the above embodiments described above, it is assumed that the passage port 212 is disposed at the +X direction side with respect to the projection port 211. However, this is not a limitation, and the passage port 212 may be disposed at the −X direction side, or may be disposed at the +Y direction side of the −Y direction side with respect to the projection port 211.

In the fourth embodiment described above, it is assumed that the ranging device 4D is fixed to the support member 7 that supports the projection optical device 36. However, this is not a limitation, and the ranging device 4D may be fixed to the projection optical device 36. In this case, the ranging device 4D may be directly fixed to the projection optical device 36, or may be indirectly fixed to the projection optical device 36 via an intervening member.

In the first and second embodiments described above, it is assumed that the cover CV1 provided to the projection port 211 and the cover CV2 provided to the passage port 212 are separate bodies. However, this is not a limitation, and the covers CV1, CV2 may be integrated with each other. In this case, it is possible to adopt a single cover in which a portion corresponding to the projection port 211 has a visible light transmissive property, a portion corresponding to the passage port 212 has an infrared light transmissive property, and the other portion has a light shielding property.

In the embodiments described above, it is assumed that the projector 1A, 1B, 1C, 1D, or 1E includes the three light modulation elements 343R, 343G, and 343B. However, this is not a limitation, and the present disclosure is also applicable to a projector including two or fewer, or four or more light modulation elements.

In the embodiments described above, it is assumed that the image projection apparatus 3 has the configuration in which the optical components are arranged in a substantially L shape as illustrated in FIG. 2. However, this is not a limitation, and the optical components constituting the image projection apparatus 3 and the layout of the optical components are not limited to those described above.

In the embodiments described above, it is assumed that the light modulation elements 343 are each configured with a transmissive liquid crystal panel in which a plane of incidence of light and a light exit surface are different. However, this is not a limitation, and the light modulation elements may each be a reflective liquid crystal panel in which a plane of incidence of light and a light exit surface are the same. Further, any light modulation element other than the liquid crystal light modulation element such as one using a device using micromirrors, for example, a digital micromirror device (DMD) may be used as long as the light modulation element is capable of modulating an incident luminous flux to form image light according to image information.

### Summary of Present Disclosure

The present disclosure will be summarized below as additional remarks.

### Additional Remark 1

A projector including
an exterior housing having a first surface provided with a projection port and a passage port,
a projection optical device configured to project image light through the projection port,
a cover having a light transmissive property, and disposed corresponding to the passage port, and
a ranging device configured to emit and receive detection light through the cover, in which
the projection optical device includes a front lens located at an exit side of the image light, and projects the image light such that a projection range of the image light moves toward one side in a second direction as moving in a first direction when a direction along a lens optical axis of the front lens is defined as the first direction and a direction orthogonal to the first direction is defined as the second direction,
the ranging device includes
a substrate, and
a sensor which includes a light emitting element configured to emit the detection light and a light receiving element configured to receive the detection light emitted from the light emitting element, and is disposed on the substrate, and
the substrate is disposed to be inclined with respect to a virtual plane orthogonal to the lens optical axis about an axis along a third direction crossing each of the first direction and the second direction so that the detection light emitted from the light emitting element points at a projection range of the image light by the projection optical device.

According to such a configuration, it is possible to make it easy to point the substrate provided with the sensor including the light emitting element and the light receiving element to the projection direction of the image light by the projection optical device. Accordingly, it is possible to make it easy to overlap the irradiation range of the detection light from the light emitting element with the irradiation range of the image light, and in addition, it is possible to make it easy to overlap the light receiving range of the detection light by the light receiving element with the irradiation range of the image light. Accordingly, it is possible to improve the ranging accuracy by the ranging device.

### Additional Remark 2

The projector described in Additional Remark 1, in which
the sensor is disposed at another side in the second direction with respect to a center in the second direction in the substrate.

According to such a configuration, it is possible to dispose the sensor provided to the substrate inclined with respect to the virtual plane described above at a position close to the cover. Accordingly, since the distance between the cover and the sensor can be shortened, it is possible to prevent a part of the detection light emitted from the light emitting element from being reflected by the inner surface of the cover to reach the light receiving element. Accordingly, it is possible to improve the ranging accuracy by the ranging device.

### Additional Remark 3

The projector described in Additional Remark 2, in which
the exterior housing includes
a groove which is provided to an inner surface of the exterior housing and in which an end portion at the other side in the second direction of the substrate is disposed, and
a support surface configured to support a portion at the one side in the second direction in the substrate.

According to such a configuration, it is possible to make it easy to arrange the substrate on which the sensor is disposed in a state of being inclined with respect to the virtual plane described above by the groove and the support surface. Accordingly, it is possible to make it easy to dispose the sensor at a position close to the cover.

### Additional Remark 4

The projector described in any one of Additional Remarks 1 to 3, further including
a pressing member configured to press the substrate toward the cover, and
a fixation member configured to fix the pressing member in a state of being in contact with the substrate.

According to such a configuration, the substrate can be fixed with the pressing member and the fixation member. Accordingly, the position of the sensor can be maintained.

### Additional Remark 5

The projector described in Additional Remark 4, in which
the fixation member is a frame, and
the frame includes
a frame portion that is in contact with an inner surface of the exterior housing and is configured to surround the projection port, and
a support portion configured to support the pressing member.

According to such a configuration, the projection port can be surrounded by the frame portion. Accordingly, it is possible to prevent light from leaking from the periphery of the projection port and to make it difficult to visually recognize the inside of the exterior housing from the periphery of the projection port. In addition, by the support portion supporting the pressing member, the pressing member can stably press the substrate toward the cover.

### Additional Remark 6

The projector described in Additional Remark 5, in which
the substrate includes a connector, and
the frame includes an opening from which the connector is exposed.

According to such a configuration, since the connector provided to the substrate is exposed through the opening, it is possible to make it easy to achieve the wiring to the connector. Accordingly, the assembling step of the ranging device can be simplified.

### Additional Remark 7

The projector described in Additional Remark 6, in which
the frame includes a guide portion provided to the frame portion and configured to guide wiring to be coupled to the connector.

According to such a configuration, it is possible to make it easy to couple the wiring to the connector with the guide portion, and in addition, the wiring coupled to the connector can be prevented from moving around in the exterior housing.

### Additional Remark 8

The projector described in Additional Remark 1 or 2, in which
the exterior housing includes a holding portion configured to hold the substrate in a state of being inclined with respect to the virtual plane.

According to such a configuration, since the exterior housing has the holding portion described above, it is unnecessary to separately provide a member for holding the substrate. Therefore, it is possible to suppress an increase in the number of components of the projector including the substrate inclined with respect to the virtual plane described above.

### Additional Remark 9

The projector described in any one of Additional Remarks 1 to 8, in which
the cover is provided to the exterior housing.

According to such a configuration, the passage port can be sealed with the cover disposed in accordance with the passage port. Accordingly, since it is possible to prevent the intrusion of dust into the exterior housing through the passage port, it is possible to improve the dust resistance of the exterior housing and, by extension, the projector.

### Additional Remark 10

The projector described in Additional Remark 1 or 2, in which
the ranging device includes a housing configured to hold the substrate in a state of being inclined with respect to the virtual plane.

According to such a configuration, since the ranging device includes the housing configured to hold the substrate, the ranging device can be unitized. Accordingly, the ranging device can easily be attached to the projector.

### Additional Remark 11

The projector described in Additional Remark 10, in which
the cover is provided to the ranging device.

According to such a configuration, since the cover disposed according to the passage port is provided to the ranging device, the positional relationship between the sensor provided to the substrate and the cover can be maintained, and in addition, it is possible to make it easy to arrange the sensor at a position close to the cover. Further, since the ranging device having the substrate can be unitized, the assembling property of the projector can be improved.

### Additional Remark 12

The projector described in Additional Remark 10 or 11, in which
the ranging device is fixed to the exterior housing.

According to such a configuration, the ranging device can easily be attached to the projector.

### Additional Remark 13

The projector described in Additional Remark 10 or 11, further including
a support member that is provided to the exterior housing and is configured to support the projection optical device, in which
the ranging device is fixed to the support member.

According to such a configuration, the projection optical device and the ranging device are fixed to the same support member. According to this, the projection optical device and the ranging device inclined with respect to the virtual plane described above related to the projection optical device can integrally be configured. Accordingly, it is possible to make it easy to adjust the inclination of the substrate with respect to the virtual plane described above. Besides the above, even when external force is applied to the projector due to falling or the like of the projector, it is possible to prevent the position of the substrate with respect to the virtual plane orthogonal to the lens optical axis related to the projection optical device from being displaced.

### Additional Remark 14

The projector described in any one of Additional Remarks 1 to 13, in which
the light emitting element is a light emitting element configured to emit infrared light.

According to such a configuration, it is possible to make it difficult for the user to recognize the detection light.

### Additional Remark 15

The projector described in Additional Remarks 1 to 14, in which
the passage port is disposed at a distance from the projection port in the third direction,
the substrate has an opposed surface opposed to an inner surface of the first surface, and
a point on the opposed surface approaches the inner surface as the point moves in the third direction.

According to such a configuration, even when the passage port is at a distance in the third direction from the projection port, it is possible to make it easy to make the irradiation range of the detection light coincide with the projection range of the image light. Accordingly, it is possible to improve the ranging accuracy by the ranging device.

### Additional Remark 16

The projector described in any one of Additional Remarks 1 to 15, in which
a center of the passage port is located at the one side in the second direction from a center of the projection port.

According to such a configuration, it is possible to make it easy to make the irradiation range of the detection light emitted from the passage port coincide with the projection range of the image light projected from the projection optical device with the deviation in the second direction. Accordingly, it is possible to improve the ranging accuracy by the ranging device.

What is claimed is:

1. A projector comprising:
an exterior housing having a first surface provided with a projection port and a passage port;
a projection optical device configured to project image light through the projection port;
a cover having a light transmissive property, and disposed corresponding to the passage port; and
a ranging device configured to emit and receive detection light through the cover, wherein
the projection optical device includes a front lens located at an exit side of the image light, and projects the image light such that a projection range of the image light moves toward one side in a second direction as moving in a first direction when a direction along a lens optical axis of the front lens is defined as the first direction and a direction orthogonal to the first direction is defined as the second direction,
the ranging device includes
a substrate, and
a sensor which includes a light emitting element configured to emit the detection light and a light receiving element configured to receive the detection light emitted from the light emitting element, and is disposed on the substrate, and
the substrate is disposed to be inclined with respect to a virtual plane orthogonal to the lens optical axis about an axis along a third direction crossing each of the first direction and the second direction so that the detection light emitted from the light emitting element points at a projection range of the image light by the projection optical device.

2. The projector according to claim 1, wherein
the sensor is disposed at another side in the second direction with respect to a center in the second direction in the substrate.

3. The projector according to claim 2, wherein
the exterior housing includes
a groove which is provided to an inner surface of the exterior housing and in which an end portion at the other side in the second direction of the substrate is disposed, and
a support surface configured to support a portion at the one side in the second direction in the substrate.

4. The projector according to claim 1, further comprising:
a pressing member configured to press the substrate toward the cover; and
a fixation member configured to fix the pressing member in a state of being in contact with the substrate.

5. The projector according to claim 4, wherein
the fixation member is a frame, and
the frame includes
a frame portion that is in contact with an inner surface of the exterior housing and is configured to surround the projection port, and
a support portion configured to support the pressing member.

6. The projector according to claim 5, wherein
the substrate includes a connector, and
the frame includes an opening from which the connector is exposed.

7. The projector according to claim 6, wherein
the frame includes a guide portion provided to the frame portion and configured to guide wiring to be coupled to the connector.

8. The projector according to claim 1, wherein
the exterior housing includes a holding portion configured to hold the substrate in a state of being inclined with respect to the virtual plane.

9. The projector according to claim 1, wherein
the cover is provided to the exterior housing.

10. The projector according to claim 1, wherein
the ranging device includes a housing configured to hold the substrate in a state of being inclined with respect to the virtual plane.

11. The projector according to claim 10, wherein
the cover is provided to the ranging device.

12. The projector according to claim 10, wherein
the ranging device is fixed to the exterior housing.

13. The projector according to claim 10, further comprising:
a support member that is provided to the exterior housing and is configured to support the projection optical device, wherein
the ranging device is fixed to the support member.

14. The projector according to claim 1, wherein
the light emitting element is a light emitting element configured to emit infrared light.

15. The projector according to claim 1, wherein
the passage port is disposed at a distance from the projection port in the third direction,
the substrate has an opposed surface opposed to an inner surface of the first surface, and
a point on the opposed surface approaches the inner surface as the point moves in the third direction.

16. The projector according to claim 1, wherein
a center of the passage port is located at the one side in the second direction from a center of the projection port.
